(19) United States
(12) Patent Application Publication
(10) Pub. No.: US 2011/0314158 A1
(43) Pub. Date: Dec. 22, 2011

(54) SYSTEM, METHOD, AND PROGRAM FOR APPLICATION ALLOCATION

(76) Inventor: Kenji Soejima, Tokyo (JP)

(21) Appl. No.: 13/148,827

(22) PCT Filed: Feb. 15, 2010
(86) PCT No.: PCT/JP2010/052149

§ 371 Date: Aug. 31, 2011

(30) Foreign Application Priority Data
Feb. 23, 2009 (JP) 2009039991

(51) Int. Cl. G06F 15/16

(52) U.S. Cl. 709/226

(57) ABSTRACT

An application allocation system is provided, by which a supposed execution environment can be obtained when an application is actually executed even in a case where the computer resources of the allocation destination dynamically varies. The allocation originating server obtains an execution condition of each component as application information, determines a component group having possibility to be allocated as an allocation candidate component group, generates a resource subscription request indicating an execution condition of the allocation candidate component group and transmits it to each allocation candidate server, and determines the allocation destination server of each component from the allocation candidate component group. Each allocation candidate server determines the executability of each allocation candidate component and transmits an application attendance request which indicates an executable allocation candidate component as an attendance object component to the allocation originating server.

### TECHNICAL FIELD

The present invention relates to a system, method, and program for application allocation.

### BACKGROUND ART

A distributed processing apparatus having a plurality of computers and by which an application is distributed to and executed by the plurality of computers is known. According to such a distributed processing apparatus, the resource of each computer is effectively used, which results in the enhancement of the execution ability of an application.

In the distributed processing apparatus, an application is divided into a plurality of components. Then, the individual components are executed by different computers. For effectively use the resources of the plurality of computers, it is important how the plurality of components are allocated to each computer.

A related technique is described in Japanese Patent Application Publication JP-P2008-4092A. The method described in this document includes: a step of providing a central management resource for receiving an on-demand provisioning request which requires a data processing system structure; a step of providing a plurality of data processing system resources which are able to perform provisioning and allocated in a group unit; and a step of providing at least one provisioning server being able to dynamically allocate the data processing system resources able to perform provisioning to a plurality of no-demand requests individually or in a group unit in response to the central management resource.

Another related technique is described in Japanese Patent Application Publication JP-P2004-326452A. The distributed processing service providing server in this document includes: a first means for receiving a service request from a first computer; a second means for allocating processing of the received service request to each of the distributed processing blocks based on information regarding the resource of the second computer; a third means for delivering the allocated processing blocks; and a fourth means for receiving a processing result of the processing block from the second computer to which the processing block is delivered, and deliver the processing result for the service request to the first processing result based on the processing result.

The followings are other related techniques the inventor is able to know: Japanese Patent Application Publication JP-P2002-521765A; JP-P2003-99410A; JP-P2004-240697A; and JP-P2005-56405A.

### CITATION LIST

### Patent Literature

### [PTL1] Japanese Patent Application Publication JP-P2008-4092A

### [PTL2] Japanese Patent Application Publication JP-P2004-326452A

### [PTL3] Japanese Patent Application Publication JP-P2002-521765A

### [PTL4] Japanese Patent Application Publication JP-P2003-99410A

### [PTL5] Japanese Patent Application Publication JP-P2004-240697A

[PTL6] Japanese Patent Application Publication JP-P2005-56405A

### SUMMARY OF INVENTION

The distributed processing service providing server described in JP-P2004-326452A determined the second computer to be allocated to each processing block based on information of the resource of the second computer. Then, each processing block is delivered to the determined second computer. According to this invention, the remaining part of computer resources can be effectively utilized.

However, the utilization condition of computer resources may dynamically varies depending on the condition of component allocation or the like. Therefore, there is a possibility that the resource information used to determine the allocation destination computer becomes different from the resource state at the time when the component is actually executed by the computer determined as the allocation destination. For example, it is assumed that 1024 MB memory is mounted on the computer being allocation destination candidate. It is also assumed that the component to be allocated requires 768 MB memory. Here, it is assumed that static information indicating that the mounted memory of a compute: being an allocation destination candidate is 1024 MB is used for determining the allocation destination computer. In this case, it is determined that the component can be allocated to the allocation destination candidate computer. However, after that, another application which requires 512 MB memory may be allocated to the allocation destination computer. In such a case, actually available memory becomes 512 MB. Namely, 768 MB required to execute the allocation object component is not assured in the allocation destination computer. As a result, the allocated application is not able to be executed.

Namely, the technique described in JP-P2004-326452A has a problem that there is a possibility that an assumed execution environment is not assured when the application is actually executed in a case where the resource of the allocation destination computer dynamically varies.

According to the present invention, an application allocation system includes: an allocation originating server; and an allocation candidate server group communicably connected to the allocation originating server. The allocation originating server comprises: an application, interpretation section for obtaining an execution condition of each component included in a component group as application information when an application including the component group is registered; a resource subscription request transmission section for determining the component group having possibility that the component group becomes allocated as an allocation candidate component group for each allocation candidate server included in the allocation candidate server group, and generating a resource subscription request which indicates an execution condition of the allocation candidate component group and transmitting the resource subscription request to each allocation candidate server; and a resource monitoring section for determining an allocation destination server of each component from the allocation candidate server group. Each allocation candidate server comprises an attendance determination section for determining whether each allocation candidate component included in the allocation candidate component group is executable or not when the resource subscription request is obtained, and transmitting an application attendance request which represents the allocation candidate component determined as executable as an attendance object component to the allocation originating server, and the resource monitoring section determines the allocation destination server based on the application attendance request.

According to another exemplary embodiment of the present invention, an application allocation system includes a plurality of servers being communicably connected to each other. Each of the plurality of servers includes: an allocation originating server part; and an allocation candidate server part. The allocation originating server part includes: an application interpretation section for obtaining an execution condition of each component included in a component group as application information when an application including the component group is registered; a resource subscription request transmission section for determining the component group having possibility that the component group becomes allocated as an allocation candidate component group for each of other servers in the plurality of servers, and generating a resource subscription request which indicates the allocation candidate component group and an execution condition of the allocation candidate component group and transmitting the resource subscription request to each of other servers; and a resource monitoring section for determining an allocation destination server of each component from a group of each of other servers. The allocation originating server part includes an attendance determination section for determining whether each allocation candidate component included in the allocation candidate component group is executable or not when the resource subscript ion request is obtained from each of other servers, generating an application attendance request which represents an executable allocation candidate component as an attendance object component, and transmitting the application attendance request to each of other servers, and the resource monitoring section determines the allocation destination server based on the application attendance request.

An application allocation apparatus according to the present invention includes: an application interpretation section for obtaining an execution condition of each component included in a component group as application information when an application including the component group is registered; a resource subscription request transmission section for determining the component group having possibility that the component group becomes allocated as an allocation candidate component group for each allocation candidate server included in the allocation candidate server group, and transmitting a resource subscription request which indicates the allocation candidate component group and an execution condition of the allocation candidate component group to each allocation candidate server; and a resource monitoring section for determining an allocation destination server of each component from the allocation candidate server group. The resource monitoring section determines the allocation destination server based on the application attendance request when each allocation candidate server determines whether each allocation candidate component included in the allocation candidate component group is executable or not when the resource subscription request is obtained, and transmits an application attendance request which represents the allocation candidate component determined as executable as an attendance object component to the allocation originating server.

An application allocated apparatus according to the present invention includes: a resource subscription request reception section for receiving a resource subscription request which indicates an allocation candidate component group having possibility of being allocated and an execution condition of the allocation candidate component group; and an attendance determination section for determining whether each allocation candidate component included in the allocation candidate component group is executable or not based on the resource subscription request, and transmitting an application attendance request which represents the allocation candidate component determined as executable as an attendance object component to the allocation originating server.

An application allocation method according to the present invention includes: a step of an allocation originating server obtaining an execution condition of each component included in a component group as application information when an application including the component group is registered; a step of the allocation originating server determining the component group having possibility that the component group becomes allocated as an allocation candidate component group for each allocation candidate server included in the allocation candidate server group; a step of the allocation originating server transmitting a resource subscription request which indicates the allocation candidate component group and an execution condition of the allocation candidate component group to each allocation candidate server; a step of each allocation candidate server determining whether each allocation candidate component included in the allocation candidate component group is executable or not when the resource subscription request is obtained; a step of each allocation candidate server transmitting an application attendance request which represents the allocation candidate component determined as executable as an attendance object component to the allocation originating server, and a step of the allocation originating server determining an allocation destination server of each component from the allocation candidate server group based on the application attendance request.

An application allocation program according to the present invention is a program for realizing the application allocation method described above.

An operation method of an application allocation apparatus in an application allocation system includes: step of obtaining an execution condition of each component included in a component group as application information when an application including the component group is registered; a step of determining the component group having possibility that the component group becomes allocated as an allocation candidate component group for each allocation candidate server included in an allocation candidate server group; a step of transmitting a resource subscription request which indicates the allocation candidate component group and an execution condition of the allocation candidate component group to each allocation candidate servers; and a step of determining whether each allocation candidate component included in the allocation candidate component group is executable or not when the resource subscription request is obtained, and a step of determining an allocation destination server of each component based on an application attendance request when the application attendance request which represents an executable allocation candidate component as an attendance object component is transmitted to the allocation originating server.

An operation program of the application allocation apparatus according to the present invention is a program for realizing the operation method of the application allocation apparatus in the application allocation system described above by a computer.

An operation method of an application allocated apparatus in an application allocation system according to the present invention includes: a step of receiving a resource subscription request which indicates an allocation candidate component group having possibility of being allocated and an execution condition of the allocation candidate component group; and a step of determining whether each allocation candidate component included in the allocation candidate component group is executable or not based on the resource subscription request, and transmitting an application attendance request which represents the allocation candidate component determined as executable as an attendance object component to the allocation originating server.

An operation program of the application allocated apparatus according to the present invention is a program for realizing the operation method of the application allocated apparatus in the application allocation system by a computer.

According to the present invention, a system, method, and program for application allocation capable of assuring an assumed execution environment when an application is actually executed even in a case where the resource of the allocation destination computer dynamically varies.

### BRIEF DESCRIPTION OF DRAWINGS

FIG. 1 is a schematic block diagram showing an application allocation system according to a first exemplary embodiment;

FIG. 2 is a flowchart showing a schematic operation of an application allocation system;

FIG. 3 is a flowchart showing the operation of steps S1 to S3 in detail;

FIG. 4 is a flowchart showing the operation of steps S4 and 55 in detail;

FIG. 5 is a flowchart showing the operation of steps S6 and S7 in detail;

FIG. 6 is a conceptual view showing an example of the resource subscription request;

FIG. 7 is a flowchart showing the operation of steps S8 and S9 in detail;

FIG. 8 is a flowchart showing the operation when it is determined not to be executable at step S9-7;

FIG. 9 is a flowchart showing the operation when it is determined to be executable at step S9-7;

FIG. 10 is a schematic view showing an application allocation system according to a second exemplary embodiment;

FIG. 11 is a flowchart showing a schematic operation of the application allocation system according to the second exemplary embodiment;

FIG. 12 is a flowchart showing the operation of steps S11 to S13 in detail;

FIG. 13 is a flowchart showing the operation of step S14 in detail; and

FIG. 14 is a schematic view showing a structure of an application allocation system according to an exemplary embodiment.

### DESCRIPTION OF EMBODIMENTS

### A First Exemplary Embodiment

A first exemplary embodiment of the present invention will be explained by referring to the accompanying drawings below.

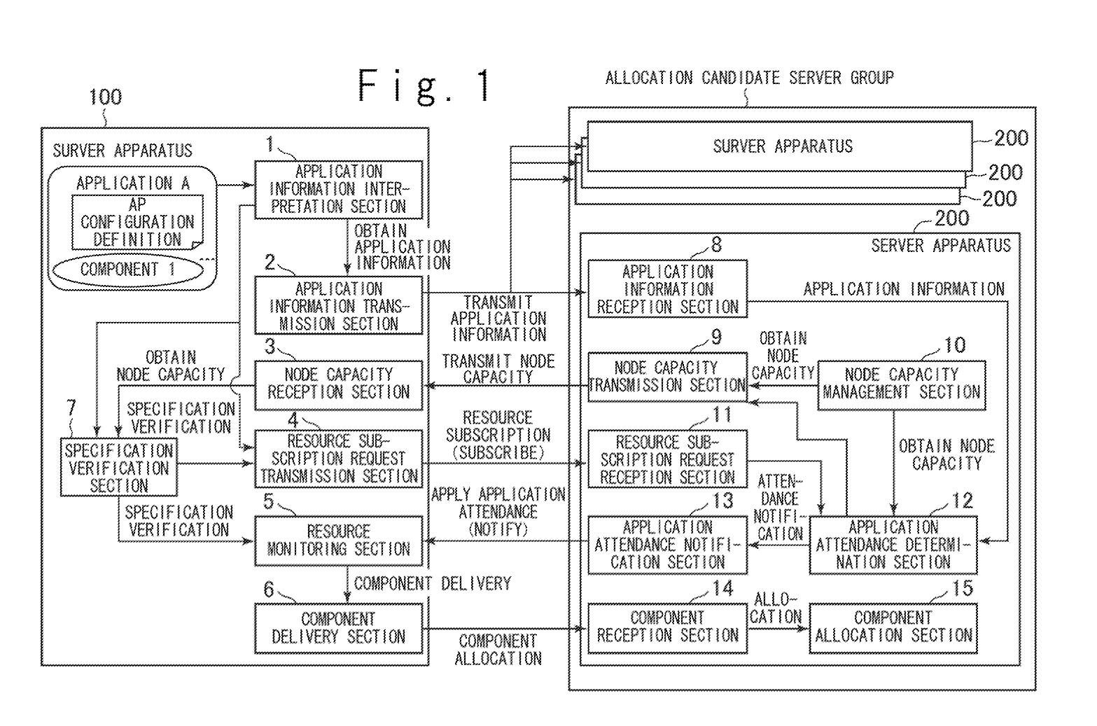

FIG. 1 is a schematic block diagram showing an application allocation system according to the present exemplary embodiment. The application allocation system includes an allocation originating server 100 (application allocation apparatus) and an allocation candidate server group (application allocated apparatus group) being allocation destination candidates of the allocation object application. In this application allocation system, the allocation object application is registered in the allocation originating server 100. Here, in the allocation object application, a plurality of components are included as a component group. The allocation originating server 100 determines an allocation destination server from the allocation candidate server group for each component. Then, each component is allocated to the determined allocation destination server.

The allocation originating server 100 is used to input the allocation object application to the system. The allocation originating server 100 includes: an application information interpretation section 1; an application information transmission section 2; a node capacity reception section 3; a resource subscription request transmission section 4; a resource monitoring section 5; a component delivery section 6; and a specification verification section 7. These are realized by executing a program (an operation program of an application allocation apparatus) installed in the ROM (Read Only Memory) of the allocation originating server 100 from a recording medium and the like exemplified by the CD-ROM or the like by a CPU.

The allocation candidate server group is a group of server apparatuses which are candidates of the allocation destination of the allocation object application. Each allocation candidate server 200 included in the allocation candidate server group includes: an application information reception section 8; a node capacity transmission section 9; a node capacity management section 10; a resource subscription request reception section 11; an application attendance notification section 13; an application attendance determination section 12; a component reception section 14; and a component allocation section 15. These are realized by executing a program (an operation program of an application allocated apparatus) installed in the ROM of each allocation candidate server 200 from a recording medium exemplified by the CD-ROM and the like by a CPU.

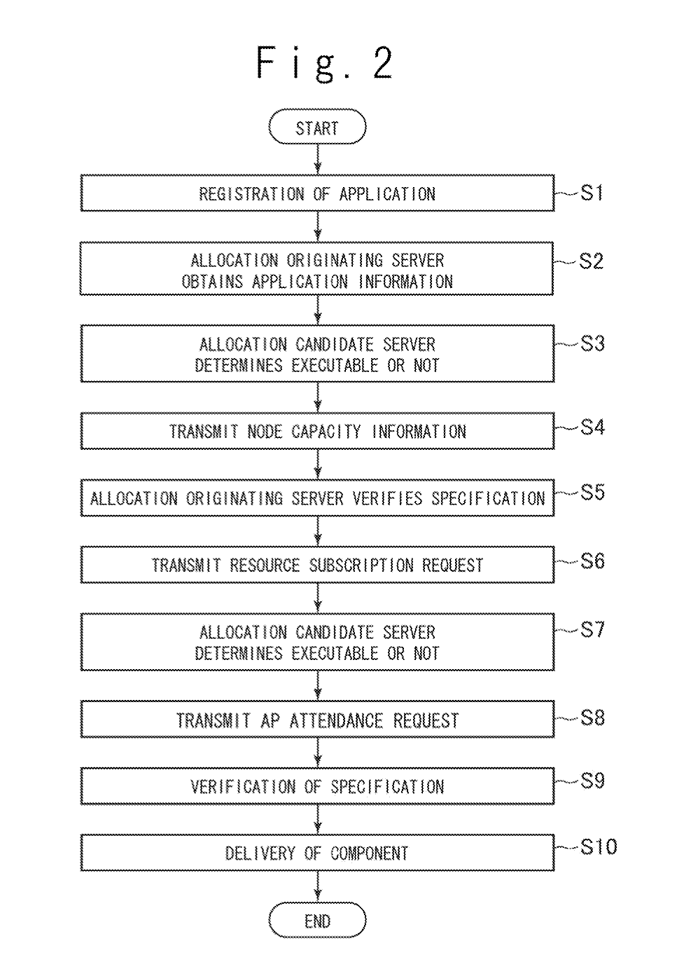

Next, a schematic operation of the application allocation system is explained. FIG. 2 is a flowchart showing the schematic operation of the application allocation system.

Step S1: registration of application

The allocation object application is registered in the allocation originating server 100 by a managing person of this application allocation system. In the allocation object application, application configuration definition information; and a component group being an execution form of the application are included. Here, each component included in the component group is assumed to have no restriction in its implementation form. The application configuration definition information indicates a list of components included in the component group. Further, in the application configuration definition information, requirements to execute each component (for example, required memory size) are linked to each component as a component execution condition.

Step S2: the allocation originating server obtains application information

The application information interpretation section 1 obtains an application configuration definition information when the allocation object application is registered and stores the information in a memory and the like which is not shown in drawings as application information. The application information is transmitted to each allocation candidate server 200 by the application information transmission section 2.

Step S3: allocation candidate server determines whether executable or not

In each allocation candidate server 200, the application information reception section 8 obtains the application information and notifies it to the application attendance determination section 12. Then, the application attendance determination section 12 determines whether an executable component is included in the allocation object application or not. Specifically, the node capacity management section 10 investigates the current application execution capacity of the allocation candidate server 200 and notifies the investigated capacity to the application attendance determination section 12 as node capacity information. In the node capacity information, for example, information about hardware like the mounted memory size, information about the component which is already allocated and the like. The application attendance determination section 12 determines whether an executable component is included or not based on the node capacity information and the application information.

Step S4: transmission of node capacity information

When an executable component is included as a result of the determination, the node capacity management section 10 transmits the node capacity information to the allocation originating server 100 by the node capacity transmission section 9.

Step S5: specification verification by the allocation originating server

In the allocation originating server 100, the node capacity information reception section 3 receives the node capacity information. Then, the specification verification section 7 performs a specification verification of each allocation candidate server 200 based on the application information and the node capacity information. Specifically, it is verified which component is able to be executed by each allocation candidate server 200.

Step S6: transmission of resource subscription request

Next, the resource subscription request transmission section 4 determines a component group having a possibility to be allocated to each allocation candidate server 200 as an allocation candidate component group based on the verification result by the specification verification section 7. Further, the resource subscription request transmission section 4 obtains the execution condition of each allocation candidate component included in the allocation candidate component group by referring to the application information. Then, the list of the allocation candidate components and their execution conditions are linked to generate a resource subscription request. The resource subscription request transmission section 4 transmits the generated resource subscription request to each allocation candidate server 200.

Step S7: the allocation candidate server determines executable or not

In each allocation candidate server 200, the resource subscription request reception section 11 receives a resource subscription request and notifies it to the application attendance determination section 12. The application attendance determination section 12 determines whether each allocation candidate component included in the allocation candidate component group is executable or not based on the resource subscription request.

Step S8: transmission of application attendance request submission

In a case where an executable allocation candidate component exists, the application attendance determination section 12 determines the allocation candidate component as an attendance object component. Then, the information indicating the attendance object component is generated as an application attendance request. Further, the application attendance determination section 12 transmits the application attendance request to the allocation originating server by the application attendance notification section 13.

Step S9: specification verification by the allocation originating server

In the allocation originating server 100, the resource monitoring section 5 receives the application attendance request from each allocation candidate server 200. In the resource monitoring section 5, the specification verification section 7 checks whether the attendance object component written in the application attendance request is executable by the issuing allocation candidate server 200 or not. And when it is executable, the issuing allocation candidate server 200 is determined as the allocation destination server of the attendance object component. Note that, in this stage, the same attendance object component may be notified from a plurality of allocation candidate servers 200. In such a case, the resource monitoring section 5 selects the optimum allocation candidate server 200 as the allocation destination server of the attendance object component.

Step S10: delivery of component

After that, the resource monitoring section 5 transmits each component to the allocation destination server by the component delivery section 6. At this stage, the component to be allocated may be already mounted on the allocation destination server. Then, the resource monitoring section 5 determines whether the component to be allocated is already mounted or not by referring to the node capacity information. When the component is already mounted, the delivery of the component is not performed and it is instructed to the allocation destination server that the mounted component is to be allocated (executed). In the allocation destination server (the allocation candidate server), the component reception section 14 receives the component or the allocation instruction of the component and the component allocation section 15 allocates the component.

By the above steps S1 to 10, each component included in the allocation object application is allocated.

According to the above-explained structure and operation, when an application is registered in the allocation originating server 100, the information indicating the execution condition of each component (resource subscription request) is transmitted to each allocation candidate server 200. Then, in each allocation candidate server 200, it is determined whether each component is executable or not. In the allocation originating server 100 side, the allocation destination server of each component is determined in accordance with the determination result of whether it is executable or not (application attendance request) in each allocation candidate server 200: Because the executability is determined by each allocation candidate server 200, it is possible to determine whether each component can be allocated or not always based on current node capacity information. As a result, even in a case where the use condition of the resources in the allocation candidate server 200 dynamically varies, it becomes possible to optimally allocate each component of the allocation object application to each allocation candidate server. Further, for example, even in a case where a server apparatus is deleted from the system or a server apparatus is newly added to the system, each component of the allocation object application can be automatically allocated.

Next, an operation method of the application allocation system according to the present exemplary embodiment is explained in detail.

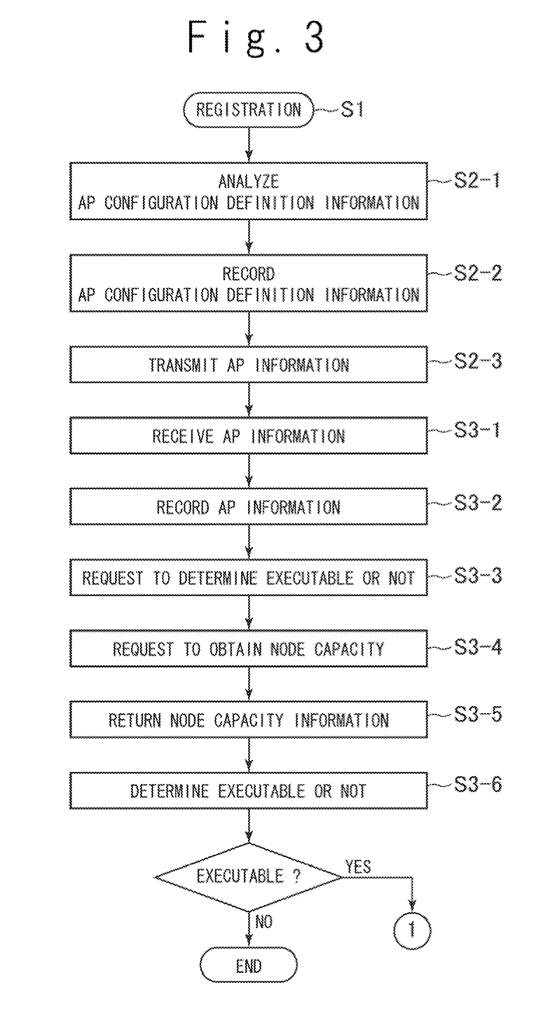

At first, the processing of steps S1 to S3 is described in detail. FIG. 3 is a flowchart showing the operation of steps S1 to S3 in detail. When the allocation object application is registered in the allocation originating server 100, the processing starts (step S1).

In the allocation originating server 100, the application information interpretation section 1 analyzes the registered allocation object application (step S2-1). The application information reception section 8 registers the application information in the recording medium (not shown in drawings) of each allocation candidate server 200 (step S3-2). The application information reception section 8 requests the application attendance determination section 12 to determine whether the component described in the application information is executable or not (step S3-3). Next, the application attendance determination section 12 requests the node capacity management section 10 to obtain the capacity information of the allocation candidate server 200 (step S3-4). Next, the node capacity management section 10 obtains the node capacity information of the allocation candidate server 200. Here, the node capacity information is assumed to include hardware information like a mounted memory size and the information (identifier) for specifying the already-allocated component. Next, the node capacity management section 10 notifies (returns) the obtained node capacity information to the application attendance determination section 12 (step S3-5).

Next, the application attendance determination section 12 determines whether an executable component exists in the component group described in the application information or not based on the application information and the node capacity information (step S3-6).

When an executable component is determined to exist at step S3-6, the processing of the subsequent flow (step S4-1) is performed. On the other hand, when no executable component exists, the processing is terminated.

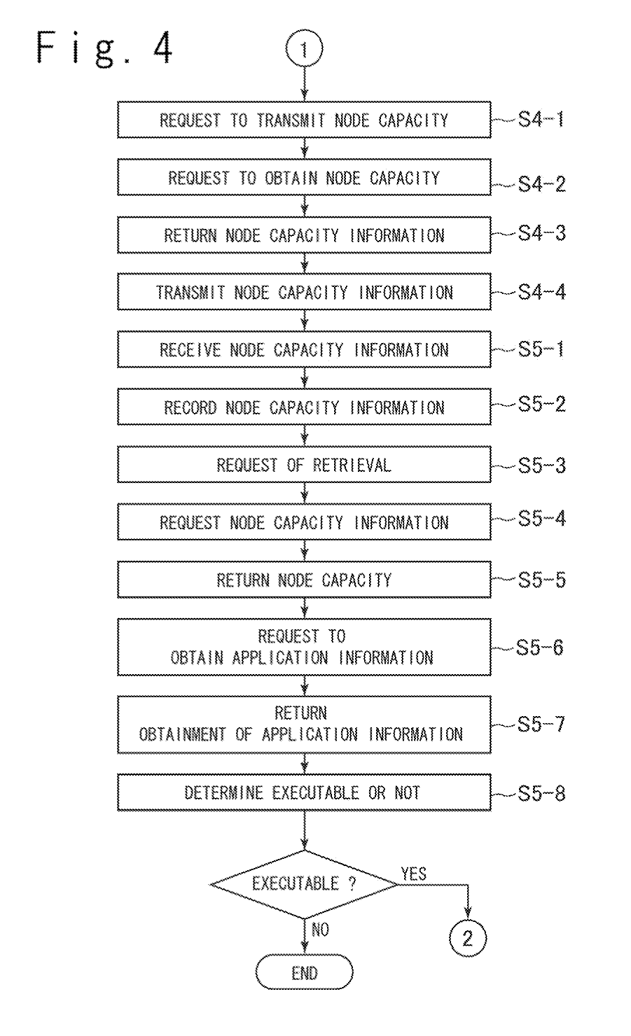

Next, the processing of steps S4 to S5 is described in detail. FIG. 4 is a flowchart showing the operation of steps S4 and S5 in detail.

The application attendance determination section 12 requests the node capacity transmission section 9 to transmit the node capacity information of the allocation candidate server 200 to the allocation originating server 100 (step S4-1). Next, the node capacity transmission section 9 requests the node capacity management section 10 to obtain the node capacity information (step S4-2). Next, the node capacity management section 10 investigates the node capacity of the allocation candidate server 200 and notifies (returns) it to the node capacity transmission section 9 as the node capacity information (step S4-3). Next, the node capacity transmission section 9 transmits the node capacity information to the allocation originating server 100 (step S4-4).

Next, in the allocation originating server 100, the node capacity reception section 3 receives the node capacity information (step S5-1). Next, the node capacity reception section 3 records the received node capacity information in the recording device (step S5-2). Next, the resource subscription request transmission section 4 requests the specification verification section 7 to retrieve the component which is executable by the allocation candidate server 200 from the component group (step S5-3). Next, the specification verification section 7 requests the node capacity reception section 3 to obtain the node capacity information of the allocation candidate server 200 (step S5-4). Next, the node capacity reception section 103 obtains the node capacity information of the allocation candidate server 200 from the recording medium and notifies (returns) it to the specification verification section 7 (step S5-5). Next, the specification verification section 7 requests the application information interpretation section 1 to obtain the application information (step S5-6). Next, the application information interpretation section 1 obtains the application information from the recording medium and notifies (returns) it to the specification verification section 7 (step S5-7). Next, specification verification section 7 determines (verifies) whether each component included in the allocation object application is executable by the allocation candidate server 200 or not based on the obtained node capacity information and the application information (step S5-8).

In a case where a component being executable by the allocation candidate server 200 exists in the allocation object application as a result of the determination at step S5-8, the processing proceeds to step S6-1. In a case where no component being executable by the allocation candidate server 200 exists in the allocation object application, the processing is terminated.

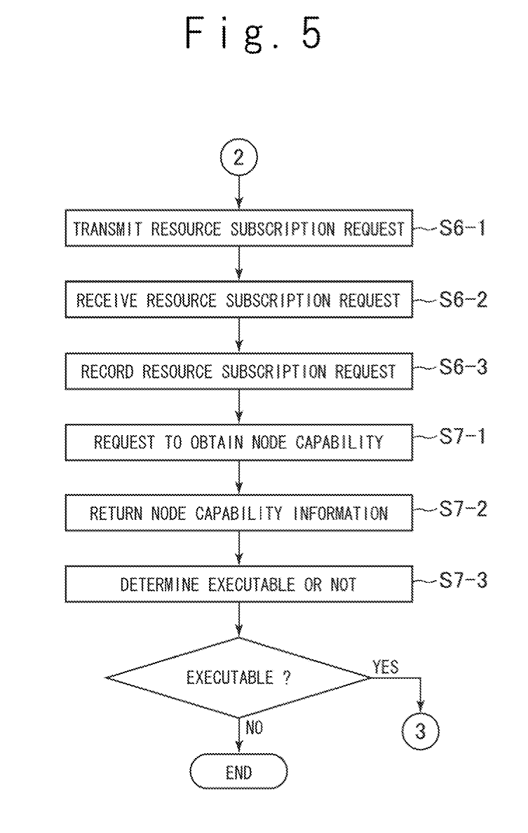

Next, the processing of steps S6 to S7 is described in detail. FIG. 5 is a flowchart showing the operation of steps S6 and S7 in detail.

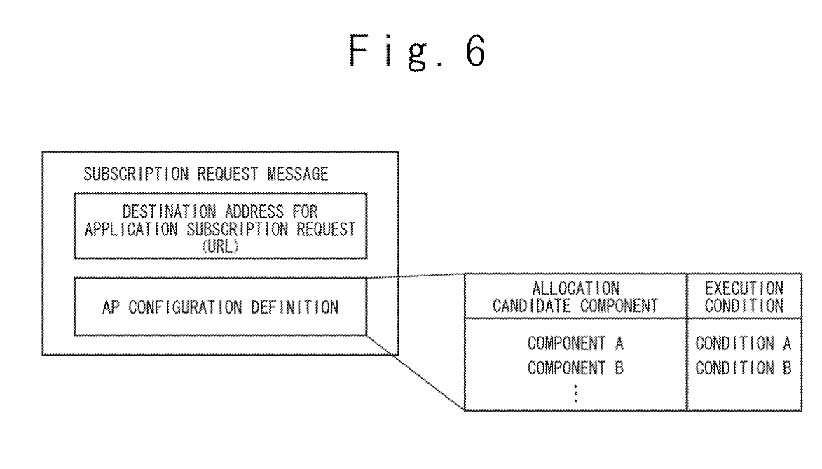

The resource subscription request transmission section 4 generates a resource subscription request. FIG. 6 is a conceptual view showing an example of a resource subscription request. The resource subscription request includes information indicating an allocation candidate component and an execution condition of the allocation candidate component. Here, as the allocation candidate component, the component being determined to be executable by the server allocation candidate 200 at step S5-8 is selected. The allocation candidate component is obtained by referring to the application information. Further, in the resource subscription request, the address information of the allocation originating server 200 is included as the application attendance request transmission address. The resource subscription request transmission section 4 transmits the generated resource subscription request to the allocation candidate server 200 (step S6-1). In the allocation candidate server 200, the resource subscription request reception section 11 receives the resource subscription request (step S6-2). Next, the resource subscription reception section 11 records the resource subscription request in the recording device (step S6-3).

Next, the application attendance determination section 12 requests the node capacity management section 10 to obtain the capacity information of the allocation candidate server 200 (step S7-1). Next, the node capacity management section 10 investigates the node capacity of the allocation candidate server 200 and notifies (returns) the investigation result to the application attendance determination section 12 as the node capacity information (step S7-2). Next, the application attendance determination section 12 determines the executability of the allocation candidate component described in the resource subscription request based on the resource subscription request and the node capacity information. At this step, the determination is performed by using the current node capacity information. Therefore, the determination result of this step may be different from that of step S3-6 (step S7-3).

As a result of the determination at step S7-3, in a case where an executable allocation candidate component exists in the resource subscription request, the processing proceeds to the next step S8-1. On the other hand, in a case where no executable allocation candidate component exists, the processing is terminated.

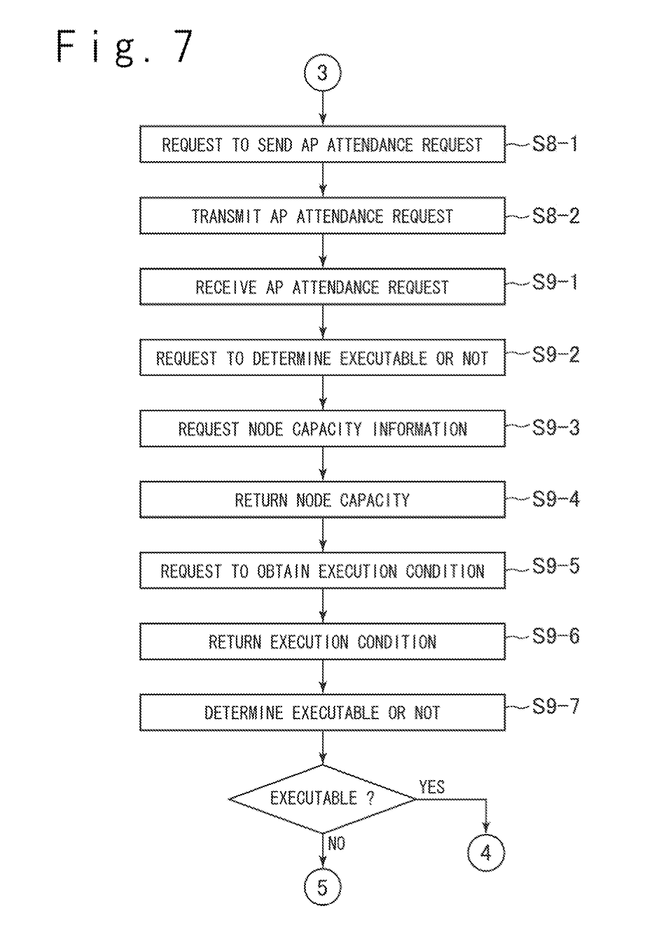

Next, the operation of steps S8 and S9 is explained in detail. FIG. 7 is a flowchart showing the operation of steps S8 and S9 in detail.

The application attendance determination section 12 requests the application attendance notification section 13 to send the application attendance request (step S8-1). Next, the application attendance notification section 13 generates the application attendance request as information and sends it to the allocation originating server 100. Here, in the application attendance request, the identifier which specifies the attendance object component and the identifier which specifies the allocation candidate server 200. As the attendance object component, the allocation candidate component being determined to be executable as a result of the determination at step S7-3 is selected (step S8-2).

In the allocation originating server 100, the resource monitoring section 4 receives the application attendance request (step S9-1). Next, the resource monitoring section 4 requests the specification verification section 7 to determine whether the attendance object component is executable by the allocation candidate server 200 or not (step S9-2). Next, the specification verification section 7 requests the node capacity reception section 3 to obtain the node capacity information of the allocation candidate server 200 (step S9-3). Next, the node capacity reception section 3 obtains the already-recorded node capacity information of the allocation candidate server 200 and notifies (returns) it to the specification verification section 7 (step S9-4). Next, the specification verification section 7 requests the application information interpretation section 1 to obtain the execution condition of the attendance object component (step S9-5). Next, the application information interpretation section 1 obtains the execution condition of the attendance object component from the application information recorded in the recording device and notifies (returns) it to the specification verification section 7 (step S9-6). Next, the specification verification section 7 determines whether the attendance object component is executable by the allocation candidate server 200 or not based on the obtained node capacity information and the obtained execution condition (step S9-7).

As a result of the determination at step S9-7, in a case where the attendance object component is determined to be executable by the allocation candidate server 200, the processing proceeds to step S10-1. On the other hand, when the attendance object component is determined not to be executable, the processing proceeds to step S10-6.

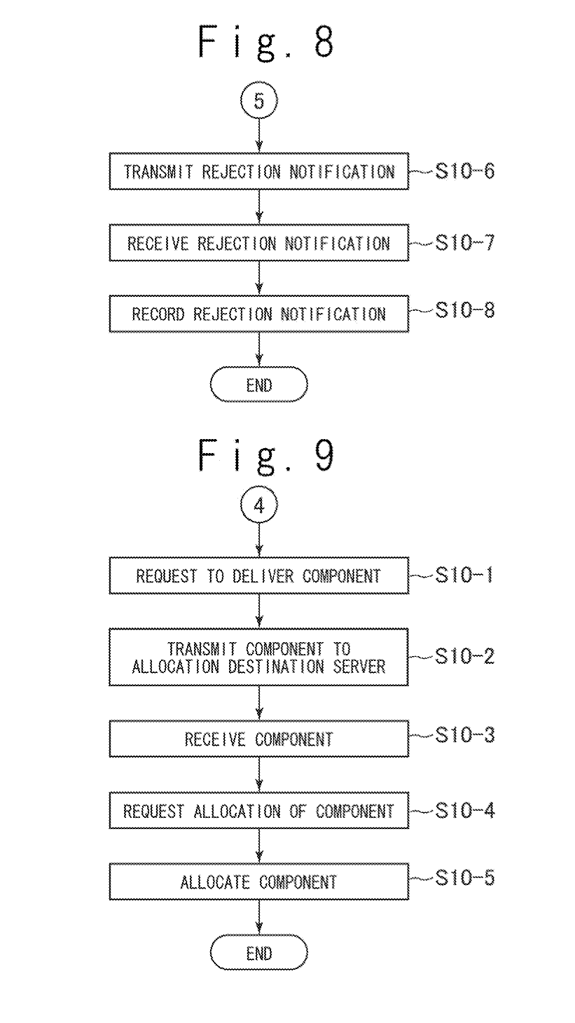

FIG. 8 is a flowchart showing the operation in a case where it is determined not to be executable at step S9-7. The resource monitoring section 5 transmits the rejection notification of the application attendance notification to the allocation candidate server 200 (step S10-6). In the allocation candidate server 200, the application attendance notification section 13 receives the rejection notification of the application attendance notification (step S10-7). The application attendance notification section 13 records the rejection notification of the application attendance notification in the recording device and terminates the processing (step S10-8).

FIG. 9 is a flowchart showing the operation when it is determined to be executable at step S9-7. The resource monitoring section 5 requests the component delivery section 6 to deliver the attendance object component (step S10-1). Next, the component delivery section 6 transmits the attendance object component to the allocation candidate server 200 being the allocation destination server (step S10-2). Next, in the allocation candidate server 200, the component reception section 14 receives the attendance object component (step S10-3). Next, the component reception section 14 requests the component allocation section 15 to allocate the attendance object component (step S10-4). Next, the component allocation section 15 allocates the attendance object component (step S10-5).

### A Second Exemplary Embodiment

Next a second exemplary embodiment will be explained.

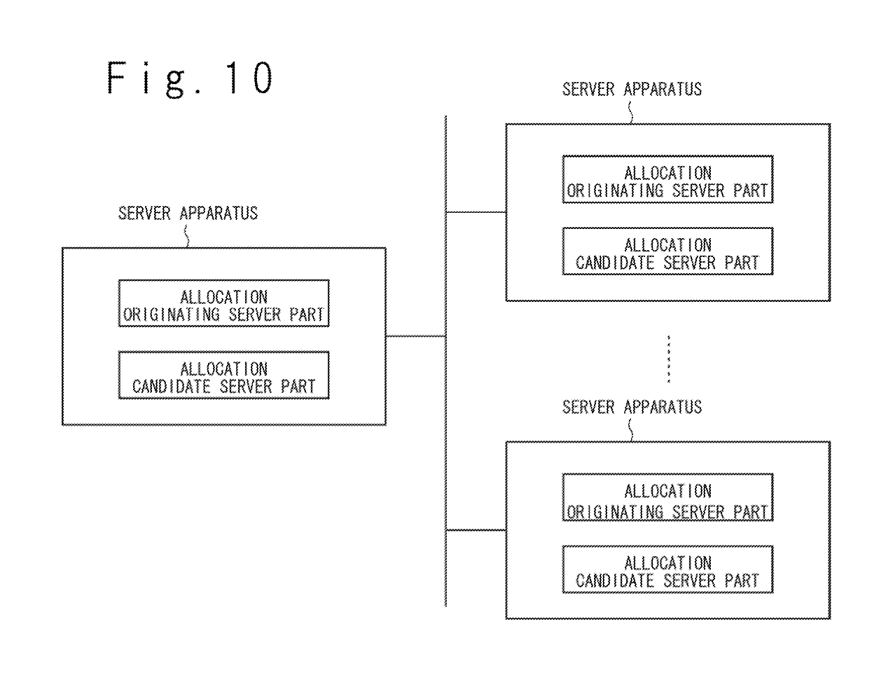

FIG. 10 is a schematic view showing an application allocation system according to the present exemplary embodiment. As shown in FIG. 10, this application allocation system includes a plurality of server apparatuses which are accessibly connected to each other. In each of the plurality of server apparatuses, an allocation originating server part and an allocation candidate server part are provided. The allocation originating server part is a part having the same functional structure as the allocation originating server of the first exemplary embodiment shown in FIG. 1. The allocation candidate server part is a part having the same functional structure as the allocation candidate server of the first exemplary embodiment shown in FIG. 1. Therefore, detailed explanation of the functional structures of the allocation originating server part and the allocation candidate server part are omitted.

It is assumed that an allocation object application is registered in one of the plurality of server apparatuses. In such a case, the one server apparatus operates as the allocation originating server by its allocation originating server part. On the other hand, each of the other server apparatuses operates as an allocation candidate server by its allocation candidate server part. Namely, the allocation object application can be registered to any of the plurality of server apparatuses.

Further, in the present invention, different from the first exemplary embodiment, the node capacity information of each server apparatus is transmitted to the other server apparatus before the allocation object application is registered.

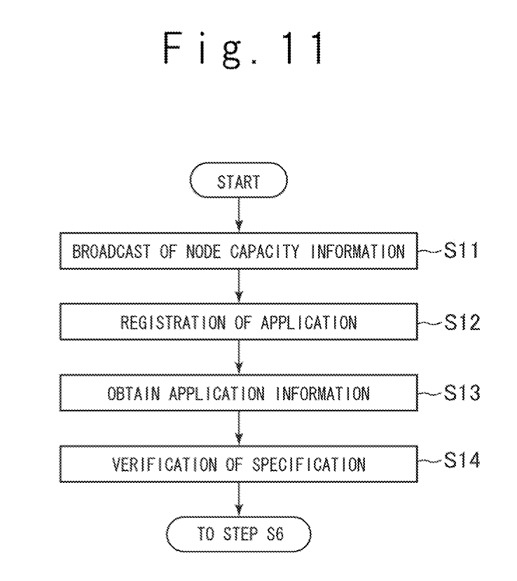

In the following, the operation method of the application allocation system according to the present invention is explained. FIG. 11 is a flowchart showing a schematic operation of the application allocation system according to the present invention.

In the present exemplary embodiment, each of the plurality of server apparatuses broadcasts the node capacity information of the own server apparatus to other server apparatus group continuously or periodically. Each server apparatus obtains the node capacity of the other server group (step S11). Here, it is assumed that an allocation object application is registered in one of the plurality of server apparatuses. In this case, the server apparatus in which the allocation object application is registered operates as the allocation originating server 100, and the other server group operates as the allocation candidate server group (step S12). The allocation originating server 100 obtains the application information of the allocation object application (step S13). Here, the node capacity information of the other server apparatus group (the allocation candidate server group) is already registered in the allocation originating server 100. Therefore, in the allocation originating server 200, the specification verification section 7 performs the verification which component is executable by the allocation candidate server 200 or not based on the node capacity information and the application information (step S14). The subsequent operation is the same as that of the step S6 and the following in the first exemplary embodiment. Therefore, their detailed explanation is omitted.

As explained above, according to the present exemplary embodiment, each of the plurality of server apparatuses is constructed to be able to functions as the allocation originating server 100 and also as the allocation candidate server 200. Therefore, it is only necessary for a managing person to register the allocation object application to any of the plurality of server apparatuses. Consequently, the convenience for the managing person can be improved.

Further, in the present exemplary embodiment, the node capacity information is broadcasted before the registration of the allocation object application. Therefore, when the application information is obtained from the allocation object application, the allocation originating server 100 can instantly perform the processing of step S14 (step S5 in the first exemplary embodiment). Namely, steps S3 and S4 in the first exemplary embodiment can be omitted so that the time from the registration of the allocation object application to the completion of the allocation can be reduced.

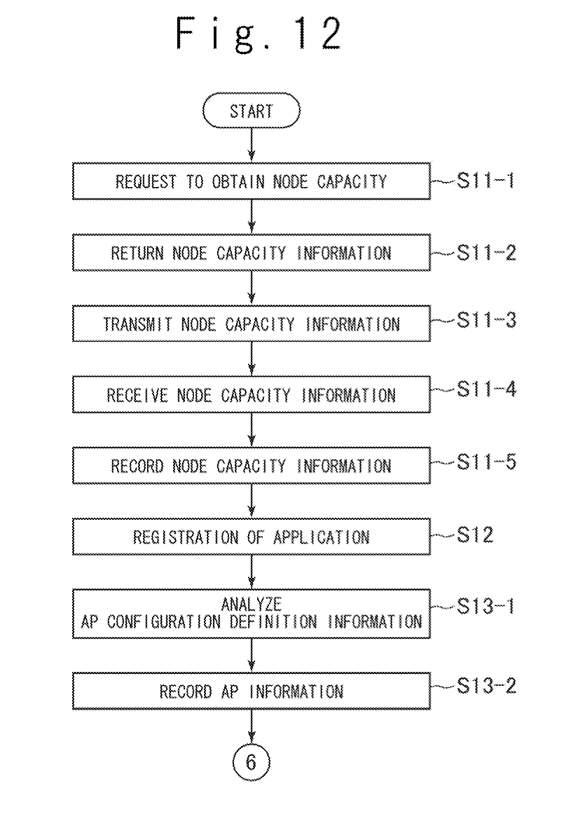

In the following, an operation of the application allocation system according to the present exemplary embodiment is explained in detail. FIG. 12 is a flowchart showing the operation of steps S11 to S13 in detail.

In each server apparatus, the node capacity transmission section 9 included in the allocation candidate server part request the node capacity management section 10 to obtain the node capacity information (step S11-1). Next, the node capacity management section 10 investigates the node capacity of the own server apparatus and returns it to the node capacity transmission section 202 as the node capacity information (step S11-2). Next, the node capacity transmission section 9 transmits the obtained node capacity information to the other server apparatus group. This operation means that the node capacity information is transmitted by the broadcast communication (step S11-3). In each server apparatus, the node capacity reception section 3 included in the allocation originating server part receives the node capacity information from the other server apparatus (step S11-4). The node capacity reception section 3 records the node capacity information in the recording device (step S11-5).

Next, it is assumed that the managing person registers an allocation object application in one of the plurality of servers (step S12).

The server apparatus in which the allocation object application is registered operates as the allocation originating server 100, and the application construction definition is analyzed by the application information interpretation section 1 (step S13-1). The application information interpretation section 1 stores the application construction definition in the recording device as the application information (step S13-2).

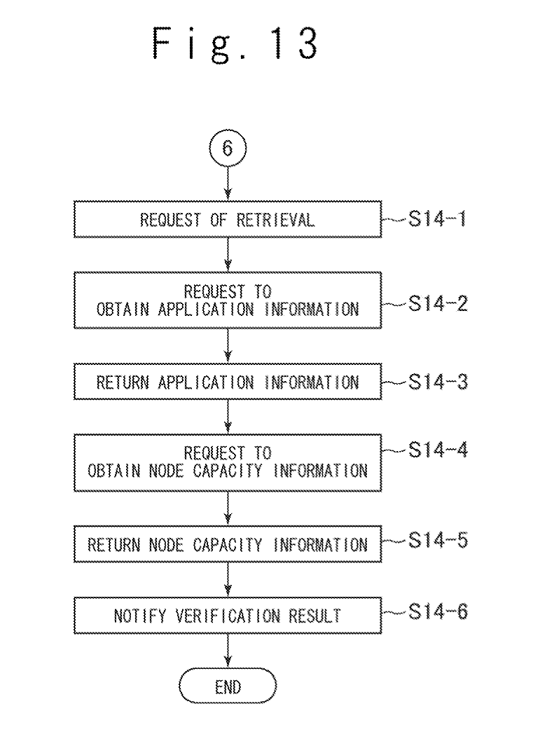

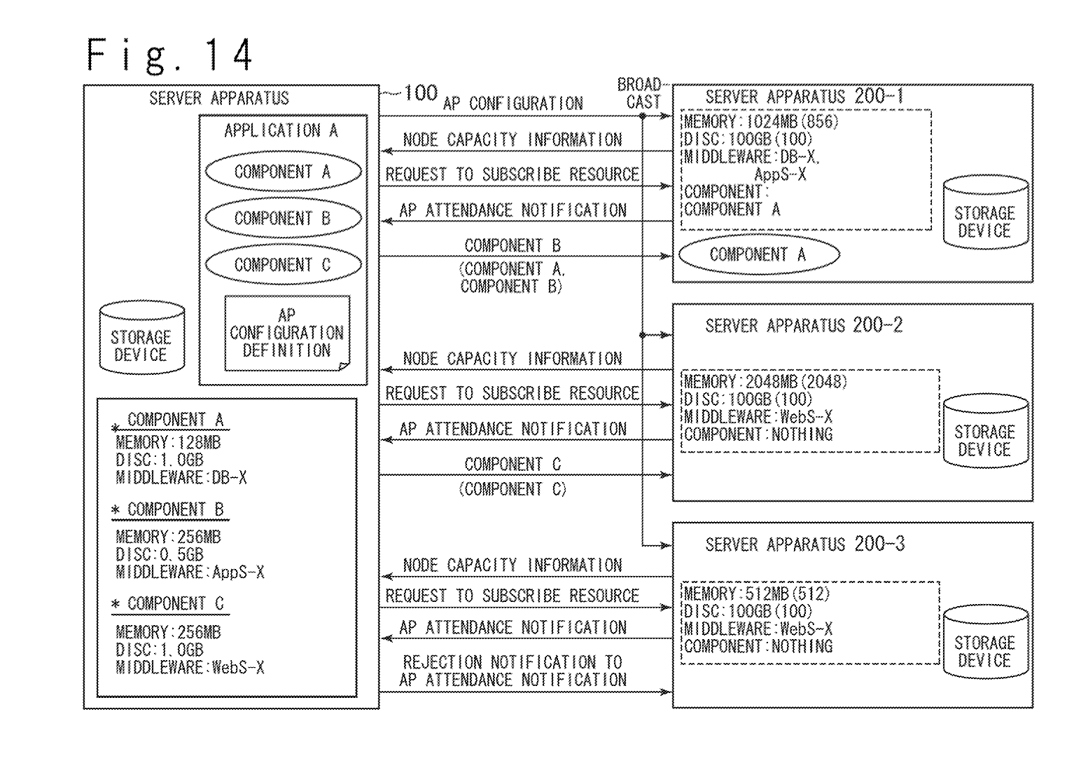

Next, the operation of step S14 is described in detail. FIG. 13 is a flowchart showing the operation of step S14 in detail.

The resource subscription request transmission section 4 requests the specification verification section 7 to retrieve the list of the allocation candidate server which is able to execute each component (step S14-1). Next, the specification verification section 7 requests the application information interpretation section 1 to obtain the application information (step S14-2). Next, the application information interpretation section 1 obtains the execution condition of each component from the recording device and notifies (returns) it to the specification verification section 7 (step S14-3). Next, the specification verification section 7 requests the node capacity reception section 3 to obtain the node capacity information (step S14-4). The node capacity reception section 3 obtains the node capacity information of each allocation candidate server 200 from the recording device and notifies it to the specification verification section (step S14-5). The specification verification section 7 obtains the list of the allocation candidate server 200 having a specification (the node capacity) matching with the execution condition of each component based on the execution condition of each component and the node capacity information of each allocation candidate server 200.

Namely, it is verified that by which allocation candidate server 200 each component is executable. Then, the verification result is notified to the resource subscription request transmission section 4 (step S14-6).

The following processing is the same as that of step S6 and subsequent processing in the first exemplary embodiment.

### Example

Next, for explaining the present invention in more detail, an example is explained. The example below corresponds to the first exemplary embodiment explained before.

FIG. 14 is a schematic view showing the application allocation system according to the present example. As shown in FIG. 14, the application allocation system includes an allocation originating server 100 which is used when an allocation object application is inputted in the system, and an allocation candidate server group (200-1, 200-2, 200-3) being server apparatuses for executing the application. The constructions of the allocation originating server group 100 and the allocation candidate server group are assumed to be the same as those of the first exemplary embodiment (refer to FIG. 1).

In the allocation candidate server group, the allocation candidate server 200-1 is assumed to have the following specification.

AMOUNT OF INSTALLED MEMORY=1024 MB

AVAILABLE AMOUNT OF MEMORY=896 MB

DISC CAPACITY=100 GB

INSTALLED MIDDLEWARE=DATABASE-X (DB-X), AND APPLICATION SERVER-X (AppS-X)

ALREADY-INSTALLED COMPONENT=COMPONENT A

Also, the allocation candidate server 200-2 is assumed to have the following specification.

AMOUNT OF INSTALLED MEMORY=2048 MB

AVAILABLE AMOUNT OF MEMORY=2048 MB

DISC CAPACITY=100 GB

INSTALLED MIDDLEWARE=WEB SERVER (Web-X)

ALREADY-INSTALLED COMPONENT=NOTHING

Also, the allocation candidate server 200-3 is assumed to have the following specification.

AMOUNT OF INSTALLED MEMORY=512 MB

AVAILABLE AMOUNT OF MEMORY=521 MB

DISC CAPACITY=100 GB

INSTALLED MIDDLEWARE=WEB SERVER (Web-X)

ALREADY-INSTALLED COMPONENT=NOTHING

Here, the component A, the component B, and the component C are assumed to be included in the allocation object application registered in the allocation candidate server 100. And the contents below are assumed to be described in the application construction definition of the allocation object application.

EXECUTION CONDITION OF COMPONENT A

REQUIRED MEMORY=128 MB

REQUIRED DISC CAPACITY=1.0 GB

REQUIRED MIDDLEWARE=DATABASE-X (DB-X)

EXECUTION CONDITION OF COMPONENT B

REQUIRED MEMORY=256 MB

REQUIRED DISC CAPACITY=0.5 GB

REQUIRED MIDDLEWARE=APPLICATION SERVER-X (AppS-X)

EXECUTION CONDITION OF COMPONENT C

REQUIRED MEMORY=256 MB

REQUIRED DISC CAPACITY=1.0 GB

REQUIRED MIDDLEWARE=Web SERVER-X (WebS-X)

The operation when :he above allocation object application is registered in the allocation originating server 100 by a managing person will be explained.

In the allocation originating server 100, the application information interpretation section 1 obtains the application construction definition from the allocation object application, and records the execution condition information of each component in the recording device as the application information. Next, the application information transmission section 2 obtains the execution condition information of the component A, the component B, and the component C, and delivers them to each allocation candidate server 200 via network. The delivering method at this time is the broadcast.

Next, each allocation candidate server 200 receives the application information (the execution condition information of each component) by the application information reception section 8 and records it to the recording device.

Here, the operation of the allocation candidate server 200-1 is explained. The allocation candidate server 200-1 determined the executability of each component based on the received application information and the node capacity information of the own server. Here, the available amount of memory of the allocation candidate server 200-1 is 856 MB. Therefore, the memory amount requirement is satisfied for all of the components A, B and C. Further, the disc capacity of the allocation candidate server 200-1 is 100 GB, so that the disc capacity requirement is satisfied for all of the components A, B and C. Further, in the allocation candidate server 200-1, the database-X and the application server-X are installed. Therefore, as the middleware requirement, the requirements of the component A and component B are satisfied, and the requirement of the component C is not satisfied. Namely, the allocation candidate server 200-1 determines that the component A and the component B are executable. Because the executable components exist, the allocation candidate server 200-1 transmits the node capacity information to the allocation originating server.

In the same manner, each of the allocation candidate servers 200-2 and 200-3 also determines whether an executable component exists or not. In the case of the allocation candidate server 200-2, because the component C is executable, it transmits the node capacity information. The allocation candidate server 200-3 similarly transmits the node capacity information because the component C is executable.

Next, the allocation originating server 100 receives the node capacity information from each allocation candidate server 200 and records it. Then, in the allocation originating server 100, it is verified that which component is executable by each allocation candidate server 200. By this operation, for the allocation candidate server 200-1, the component A and the component B are extracted as executable components. For the allocation candidate server 200-2, the component C is extracted as an executable component. For the allocation candidate server 200-3, the component C is extracted as an executable component.

The allocation originating server 100 generates a resource subscription request and transmits it to each allocation candidate server 200. At this time, to the allocation candidate server 200-1, the execution condition information of the components A and B is transmitted as the resource subscription request. To the allocation candidate servers 200-2 and 200-3, the execution condition information of the component C is transmitted as the resource subscription request.

When receiving the resource subscription request, each allocation candidate server 200 records it in the recording device. Then, the component described in the resource subscription request (allocation candidate component) is determined to be executable or not. Though the determination at this stage becomes similar to that described before, because the determination is based on the current node capacity information, it may be different from the determination result described before. However, in the present invention, the determination result is assumed to be the same as that described before. If the allocation candidate component is executable, each allocation candidate server 200 transmits the application attendance request to the allocation originating server 100. Specifically, the allocation candidate server 200-1 determines the components A and B as the attendance object components and transmits them to the application attendance request. The allocation candidate servers 200-2 and 200-3 determine the component C as the attendance object component and transmit it as the application attendance request.

When receiving the application attendance request from each allocation candidate server 200, the allocation originating server 100 checks that the attendance object component is not allocated by referring to the application information. Then, by comparing the capacity information of each node which is already obtained and the execution condition of the attendance object component, the executability is determined. The allocation destination server of the attendance object component is determined based on the determination result.

Specifically, the allocation candidate server 200-1 is determined as the allocation destination server of the attendance object component (the components A and B) transmitted from the allocation candidate server 200-1. At this stage, the allocation originating server 100 determines whether the component A or B is already mounted on the allocation destination server (allocation candidate server 200-1) by referring to the node capacity information. On the allocation candidate server 200-1, the component A is already mounted. Therefore, the allocation originating server 100 only transmits the component B to the allocation candidate server 200-1. Then, the execution instruction of the component A is notified to the allocation originating server 200-1.

On the other hand, from the allocation candidate server 200-2 and the allocation originating serer 200-2, the same component (the component C) is notified to the allocation originating server 100 as the attendance object component. In this case, the allocation originating server 100 determines whether the component C is already mounted on any of the allocation candidate servers 200-2 and 200-3 or not by referring to the node capacity information. When it is mounted, the mounted allocation candidate server 200 is preferentially determined as the allocation destination server. In the present exemplary embodiment, the attendance object component (the component C) is not mounted on any of the allocation candidate servers. In this case, the allocation originating server 100 determines the allocation candidate server which notifies the application attendance request in first as the allocation destination server. Here, as determination condition at determining the allocation destination server, a different condition may be used. In the present exemplary embodiment, one to which the application attendance request from the allocation candidate server 200-2 is sent is determined. The allocation originating server 100 determines the allocation candidate server 200-2 as the allocation destination server. Because the component C is not mounted on the allocation candidate server 200-2, the allocation originating server 100 delivers the component C to the allocation candidate server 200-3 to allocate it. The allocation originating server 100 returns the application attendance notification rejection notification for the application attendance request from the allocation candidate server 200-3. When receiving the application attendance notification rejection notification, the allocation candidate server 200-3 records the notification in the recording device and terminates the processing. On the other hand, the allocation candidate servers 200-1 and 200-2 receive and allocate the components B and C, respectively, and terminate the processing.

By the above processing, the allocation of the allocation object application is completed.

In the above, the present invention is explained by referring to some exemplary embodiments and examples. However, the present invention is not limited to the exemplary embodiments and examples. A person skilled in the art can appropriately modify or change the construction or details of the present invention in a scope of the technical idea of the present invention described in the claims.

This application is based upon and claims the benefit of priority from Japanese patent application No. 2009-039991, filed on Feb. 23, 2009, the disclosure of which is incorporated herein its entirety by reference.

1. An application allocation system comprising:
an allocation originating server; and
an allocation candidate server group communicably connected to the allocation originating server,
wherein the allocation originating server comprises:
an application interpretation section configured to obtain an execution condition of each component included in a component group as application information when an application including the component group is registered;
a resource subscription request transmission section configured to determine the component group having possibility that the component group becomes allocated as an allocation candidate component group for each allocation candidate server included in the allocation candidate server group, and generate a resource subscription request which indicates an execution condition of the allocation candidate component group and transmit the resource subscription request to said each allocation candidate server; and
a resource monitoring section configured to determine an allocation destination server of said each component from the allocation candidate server group,
wherein said each allocation candidate server comprises an attendance determination section configured to determine whether each allocation candidate component included in the allocation candidate component group is executable or not when the resource subscription request is obtained, and transmit an application attendance request which represents the allocation candidate component determined as executable as an attendance object component to the allocation originating server, and
the resource monitoring section is configured to determine the allocation destination server based on the application attendance request.

2. The application allocation system according to claim 1, wherein the allocation originating server further comprises:
an application information transmission section configured to transmit the application information to said each allocation candidate server; and
a specification verification section configured to verify which component among the component group is executable by said each allocation candidate server, and
said each allocation candidate server further comprises a node capacity management section configured to generate node capacity information which indicates own application execution capacity and transmit the node capacity information to the allocation originating server,
the attendance determination section is configured to determine whether an executable component is included in the application or not when the application information is received,
the node capacity management section is configured to transmit the node capacity information to the allocation originating server when the executable component is determined to be included by the attendance determination section,
the specification verification section is configured to perform the verification based on the node capacity information and the application information, and
the resource subscription request transmission section is configured to determine the allocation candidate component group based on a result of the verification performed by the specification verification section.

3. The application allocation system according to claim 2, wherein the resource monitoring section is configured to determine whether the attendance object component is mounted on said each allocation candidate server or not when the attendance object component is same in a plurality of application attendance requests obtained from a plurality of allocation candidate servers included in the allocation candidate server group, and determine said each allocation candidate server being already mounted as an allocation destination server of the attendance object component preferentially.

4. An application allocation system comprising a plurality of servers being communicably connected to each other,
wherein each of the plurality of servers comprises:
an allocation originating server part; and
an allocation candidate server part, and
the allocation originating server part comprises:
an application interpretation section configured to obtain an execution condition of each component included in a component group as application information when an application including the component group is registered;
a resource subscription request transmission section configured to determine the component group having possibility that the component group becomes allocated as an allocation candidate component group for each of other servers in the plurality of servers, and generate a resource subscription request which indicates the allocation candidate component group and an execution condition of the allocation candidate component group and transmit the resource subscription request to said each of other servers; and
a resource monitoring section configured to determine an allocation destination server of said each component from a group of said each of other servers,
wherein the allocation originating server part comprises an attendance determination section configured to determine whether each allocation candidate component included in the allocation candidate component group is executable or not when the resource subscription request is obtained from said each of other servers, generate an application attendance request which represents an executable allocation candidate component as an attendance object component, and transmit the application attendance request to said each of other servers, and
the resource monitoring section is configured to determine the allocation destination server based on the application attendance request.

5. The application allocation system according to claim 4, wherein the allocation candidate server part further comprises a node capacity management section configured to generate node capacity information which indicates an own application execution capacity, and transmit the node capacity information to all of said each of other servers, and
The allocation originating server part comprises a specification verification section configured to
a specification verification section configured to verify which component is executable by which server based on the node capacity information and the application information, and
the resource monitoring section is configured to determine the allocation destination server based on the application attendance request and a result of the verification performed by the specification verification section.

6. The application allocation system according to claim 5, wherein the node capacity management section is configured to transmit the node capacity information before the application is registered in said each of other servers.

7. An application allocation apparatus comprising:
an application interpretation section configured to obtain an execution condition of each component included in a component group as application information when an application including the component group is registered;
a resource subscription request transmission section configured to determine the component group having possibility that the component group becomes allocated as an allocation candidate component group for each allocation candidate server included in the allocation candidate server group, and transmit a resource subscription request which indicates the allocation candidate component group and an execution condition of the allocation candidate component group to said each allocation candidate server; and
a resource monitoring section configured to determine an allocation destination server of said each component from the allocation candidate server group,
wherein the resource monitoring section is configured to determine the allocation destination server based on the application attendance request when said each allocation candidate server determines whether each allocation candidate component included in the allocation candidate component group is executable or not when the resource subscription request is obtained, and transmits an application attendance request which represents the allocation candidate component determined as executable as an attendance object component to the allocation originating server.

8. An application allocated apparatus comprising:
a resource subscription request reception section configured to receive a resource subscription request which indicates an allocation candidate component group having possibility of being allocated and an execution condition of the allocation candidate component group; and
an attendance determination section configured to determine whether each allocation candidate component included in the allocation candidate component group is executable or not based on the resource subscription request, and transmit an application attendance request which represents the allocation candidate component determined as executable as an attendance object component to the allocation originating server.

9. An application allocation method comprising:
an allocation originating server obtaining an execution condition of each component included in a component group as application information when an application including the component group is registered;
the allocation originating server determining the component group having possibility that the component group becomes allocated as an allocation candidate component group for each allocation candidate server included in the allocation candidate server group;
the allocation originating server transmitting a resource subscription request which indicates the allocation candidate component group and an execution condition of the allocation candidate component group to said each allocation candidate server;
said each allocation candidate server determining whether each allocation candidate component included in the allocation candidate component group is executable or not when the resource subscription request is obtained;
said each allocation candidate server transmitting an application attendance request which represents the allocation candidate component determined as executable as an attendance object component to the allocation originating server, and
the allocation originating server determining an allocation destination server of said each component from the allocation candidate server group based on the application attendance request.

10. (canceled)

11. An operation method of an application allocation apparatus in an application allocation system comprising:
obtaining an execution condition of each component included in a component group as application information when an application including the component group is registered;
determining the component group having possibility that the component group becomes allocated as an allocation candidate component group for each allocation candidate server included in an allocation candidate server group;
transmitting a resource subscription request which indicates the allocation candidate component group and an execution condition of the allocation candidate component group to said each allocation candidate servers; and
determining whether each allocation candidate component included in the allocation candidate component group is executable or not when the resource subscription request is obtained, and
determining an allocation destination server of said each component based on an application attendance request when the application attendance request which represents an executable allocation candidate component as an attendance object component is transmitted to the allocation originating server.

12. (canceled)

13. An operation method of an application allocated apparatus in an application allocation system comprising:
receiving a resource subscription request which indicates an allocation candidate component group having possibility of being allocated and an execution condition of the allocation candidate component group; and
determining whether each allocation candidate component included in the allocation candidate component group is executable or not based on the resource subscription request, and transmitting an application attendance request which represents the allocation candidate component determined as executable as an attendance object component to the allocation originating server.

14. (canceled)

15. A computer-readable, non-transitory medium storing an application allocation program, which when executed by a computer, causes the computer to perform the application allocation method according to claim 9.

16. A computer-readable, non-transitory medium storing a program, which when executed by a computer, causes the computer to perform the operation method according to claim 11.

17. A computer-readable, non-transitory medium storing a program, which when executed by a computer, causes the computer to perform the operation method according to claim 13.
